(19) United States
(12) Patent Application Publication
(10) Pub. No.: US 2003/0184926 A1
(43) Pub. Date: Oct. 2, 2003

(54) Hybrid switch module for an AC power capacitor

(75) Inventors: Chin-Chang Wu, Kaohsiung (TW); Hurng-Liang Chou, Kaohsiung (TW); Kuen-Der Wu, Kaohsiung (TW); Yao-Jen Chang, Kaohsiung (TW)

Correspondence Address: BACON & THOMAS, PLLC, 625 SLATERS LANE, FOURTH FLOOR, ALEXANDRIA, VA, 22314

(73) Assignee: UIS Abler Electronics Co., Ltd., Taipei Hsien (TW)

(21) Appl. No.: 10/331,765

(22) Filed: Dec. 31, 2002

(30) Foreign Application Priority Data
Apr. 1, 2002 (TW) 91106685

(51) Int. Cl. H02H 3/00

(52) U.S. Cl. 361/2

(57) ABSTRACT

A hybrid switch module comprises an auxiliary thyristor switch turning on/off an AC power capacitor, an electromagnetic switch connected parallel thereto, and a control circuit outputting control signals with time difference thereto. During the turn on process, a control signal turns on the thyristor switch while the voltage across the hybrid switch module at the zero crossing point, and then turns on the electromagnetic switch that minimizes an inrush current on the energized capacitor. The thyristor is disabled as the electromagnetic switch is turned on. During the turn off process, a control signal turns on the thyristor switch, and then the electromagnetic switch is turned off to avoid an electric arc due to the voltage across the electromagnetic switch. The driving signal of the thyristor switch is disabled after the electromagnetic switch is completely turned off, and the thyristor switch is turned off while current passing through is at the zero crossing point.

### BACKGROUND OF THE INVENTION

1. Field of the Invention

The present invention is related to a hybrid switch module, constructed by a parallel connection of a thyristor switch and an electromagnetic switch, for an AC power capacitor and more particularly to be applied to turn on or off the AC power capacitor in a distribution power system, the control circuit of inventive hybrid switch module generating the output signals with time difference to the thyristor switch and the electromagnetic switch respectively.

2. Description of the Related Art

Most of loads in distribution power system have the characteristic of inductance, and it will result in the poor power factor. Hence, it requires a larger current for the identical real power that reduces power efficiency of the distribution power system and degrades the performance of voltage regulation of the load side. For solving the above problems, power substation or power consumers generally install AC power capacitors or an automatic power factor regulator to the distribution power system, so as to compensate the reactive power to increase the entire power factor. In some distribution power system, the capacity of applied AC power capacitor is about 25% to 35% of total capacity, and in some other distribution power system even exceeds about 50%, according to research reports.

In conventional, an electromagnetic switch is used to turn on or off the AC power capacitor to a power feeder. However, it must take about ten milliseconds or more for actuating the electromagnetic switch that fails to turn on or off the switch at precise time. The current of the AC power capacitor is determined by the following equation:

i=C*dv/dt

The current of the AC power capacitor is proportional to the differential of the voltage across the AC power capacitor. The different voltage value between the power feeder and the AC power capacitor, i.e. the voltage across switch, determines the voltage value on the AC power capacitor at an instant when the AC power capacitor is initially turned on. Turning on the switch results in an instantaneous voltage change on the AC power capacitor if the AC power capacitor is turned on at the instant when the voltage between the power feeder and the AC power capacitor is not zero. Consequently, it results in a considerable inrush current flowing through the AC power capacitor and the electromagnetic switch at the instant of turning on that may shorten the life of the AC power capacitor. Hence, the capacity of electromagnetic switch must be enlarged significantly to withstand the inrush current of the AC power capacitor at the instant of turning on. At the instant of turning off, it results in electric arc on the contactor of the electromagnetic switch if the AC power capacitor is turned off at the instant when the current flowing through the AC power capacitor cannot be turned off at the zero crossing point. Consequently, the electric arc also results in shortening the life of the AC power capacitor. However, both the inrush current at turning on and the transient high voltage due to electric arc at turning off may result in shortening not only the life of AC power capacitor but also the life of the electromagnetic switch.

Due to the fast development of semiconductor technique, a traditional high-voltage/current endurable thyristor can be operated as a switch to turn on and turn off the AC power capacitor from power feeder. Because the transition time of thyristor is very short (only a few microseconds), it can be precisely controlled and incorporated into the power feeder while the voltage on the AC power capacitor being near zero as well as the voltage on the AC power capacitor being similar to that of the power feeder (the switch's voltage at zero). Hence, it can reduce the inrush current on the AC power capacitor during the turn on process. On the other hand, the thyristor generates no electric arc due to that the AC power capacitor is automatically turned off its current at the zero crossing point. However, a significant voltage drop on the thyristor is produced during the conduction period. A significant power loss occurs on the thyristor switch of the AC power capacitor on which passing a significant large current due to incorporating into the distribution power system depending upon the compensation reactive power. The above power loss may result in an increase of the thyristor's temperature. In order to avoid the problem of overheat on the thyristor, an additional huge heatsink and cooling fan are necessary. Therefore, the entire efficiency of the thyristor applied to the AC power capacitor's switch is lower than that of the conventional electromagnetic switch, besides, the volume and weight are also larger than that of conventional electromagnetic switch.

The present invention intends to provide a hybrid switch module for AC power capacitor combining an electromagnetic switch with a thyristor switch. A control circuit produces output signals with time difference to actuate the thyristor switch and the electromagnetic switch respectively. When the AC power capacitor is turned on, it can precisely control conduction time of its switch for reducing inrush current at the instant of turning on. Hence, the capacity rating of the electromagnetic switch can be selected significantly smaller than that of the conventional electromagnetic switch using in switching AC power capacitor as a singular switch. After the thyristor switch and the electromagnetic switch are successively turned on, the thyristor switch is disabled. Consequently, it can avoid power consumption of long-term current flowing through the thyristor switch, eliminate requirement of vast dimension heatsink and cooling fan, and improve power efficiency of entire reactive power compensation system. In the process of turning off the AC power capacitor, the thyristor switch is enabled again immediately when the electromagnetic switch is off. Because the thyristor is controlled to be turned off after the electromagnetic switch is completely turned off, the electric arc on the electromagnetic switch can be avoided and it may result in an increase in the life of AC power capacitor and electromagnetic switch. After the electromagnetic switch is turned off, the control signal for turning on the thyristor switch will be removed, and the thyristor will be turned off at the current flowing through the thyristor switch at the zero crossing point. Then, the AC power capacitor is switched off from a power feeder while the current flowing through the AC power capacitor being at the zero crossing point.

From the above, it can be found that the thyristor switch of the present invention is operated as an auxiliary switch both in the turn on and the turn off processes, hence, the thyristor is only operated a very short time both in the turn on and the turn off processes. Besides, the thyristor can endure a large over current in a short time. Therefore, the capacity rating of thyristor can be very small as comparing with that of the conventional thyristor, and it does not use the heatsink and cooling fan. The inventive hybrid switch can suppress the inrush current at the instant of turning on the AC power capacitor and transient high voltage at the instant of turning off the AC power capacitor to thereby ensure turning on or off the AC power capacitor unaffecting its life.

### SUMMARY OF THE INVENTION

The primary objective of the present invention is to provide a hybrid switch circuit for an AC power capacitor. The inventive hybrid switch module comprises a thyristor switch and an electromagnetic switch connected in parallel to form a switch being adapted to turn on or turn off the AC power capacitor. In order to minimize the inrush current of the AC power capacitor, a control signal generated by a control circuit precisely controls the thyristor switch to turn on while the voltage across the hybrid switch module at the zero crossing point. Consequently, it results in the increase in the life of the AC power capacitor and availability for relatively small capacity rating of the electromagnetic switch.

The secondary objective of the present invention is to provide the hybrid switch for the AC power capacitor. The inventive hybrid switch module comprises a thyristor switch and an electromagnetic switch connected in parallel to form a switch being adapted to turn on or turn off the AC power capacitor. After the thyristor switch and the electromagnetic switch are successively turned on, the thyristor switch subsequently will be disabled automatically. Since actuating duration of the thyristor switch is only one to two cycles, and the thyristor can endure a large overcurrent in a short time. It results in availability for relatively small rating of the thyristor switch and elimination for additional heatsink and cooling fan to thereby increase the efficiency of an entire reactive power compensation system.

Another objective of the present invention is to provide the hybrid switch for the AC power capacitor. The inventive hybrid switch module comprises a thyristor switch and an electromagnetic switch connected in parallel to form a switch being adapted to turn on or turn off the AC power capacitor. The inventive hybrid switch module is turned off by a control signal by means of terminating a drive signal for an electromagnetic switch at the first instant. The thyristor switch is enabled again at the instant of turning off the electromagnetic switch and it may avoid electric arc on the electromagnetic switch during the turn off process. Subsequently, the drive signal for a thyristor switch is removed after turning off completely the electromagnetic switch, and the thyristor switch is turned off automatically while the zero crossing point of AC power capacitor current. Consequently, it may extend the life of the AC power capacitor and the electromagnetic switch.

The present invention is the hybrid switch module for the AC power capacitor. The hybrid switch module for AC power capacitor mainly comprises a thyristor switch and an electromagnetic switch electrically connected thereto in parallel and a control circuit. The control circuit is used to output control signals with time difference to the thyristor switch and the electromagnetic switch respectively. During the turn on process, in order to minimize the inrush current on energizing the AC power capacitor, the control signal triggers and turns on the thyristor switch while the voltage across the hybrid switch module at the zero crossing point, and then a driving signal actuates to turn on the electromagnetic switch. The thyristor is disabled automatically as the electromagnetic switch is turned on. During the turn off process, the thyristor switch is enabled again, and then the electromagnetic switch is turned off to avoid the electric arc due to the voltage across the electromagnetic switch at the instant of turning off the electromagnetic switch. The driving signal of the thyristor switch is removed after the electromagnetic switch is completely turned off, and the thyristor switch is turned off while current passing through is at the zero crossing point.

Other objectives, advantages and novel features of the invention will become more apparent from the following detailed description and the accompanying drawings.

### BRIEF DESCRIPTION OF THE DRAWINGS

The present invention will now be described in details with references to the accompanying drawings herein:

FIG. 1 is a block diagram of a hybrid switch module for an AC power capacitor in accordance with the present invention;

FIG. 2 is a control block diagram of the hybrid switch module for the AC power capacitor in accordance with a first embodiment of the present invention;

FIG. 3 is a control block diagram of the hybrid switch module for the AC power capacitor in accordance with a second embodiment of the present invention;

FIG. 4 is a circuitry diagram of the hybrid switch module and the AC power capacitor applying in single-phase distribution power system in accordance with the present invention;

FIG. 5 is a circuitry diagram of the hybrid switch module and a Y connection AC power capacitor applying in 3-phase 3-wire distribution power system in accordance with the present invention;

FIG. 6 is a circuitry diagram of the hybrid switch module and a delta connection AC power capacitor applying in 3-phase 3-wire distribution power system in accordance with the present invention; and

FIG. 7 is a circuitry diagram of the hybrid switch module applying in 3-phase 4-wire distribution power system in accordance with the present invention.

### DETAILED DESCRIPTION OF THE INVENTION

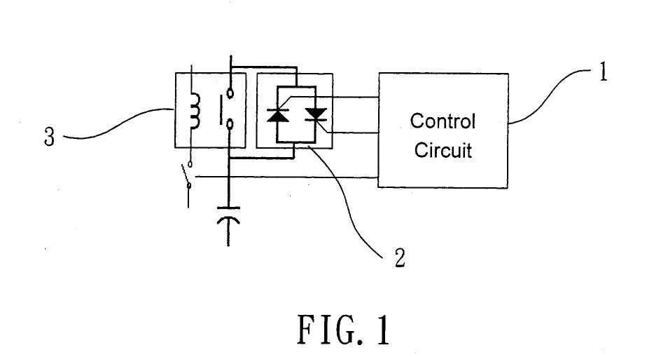

FIG. 1 illustrates a block diagram of a hybrid switch module for an AC power capacitor in accordance with the present invention. Referring to FIG. 1, the hybrid switch module for AC power capacitor in accordance with the present invention includes a control circuit 1, a thyristor switch 2, and an electromagnetic switch 3 electrically connected thereto in parallel.

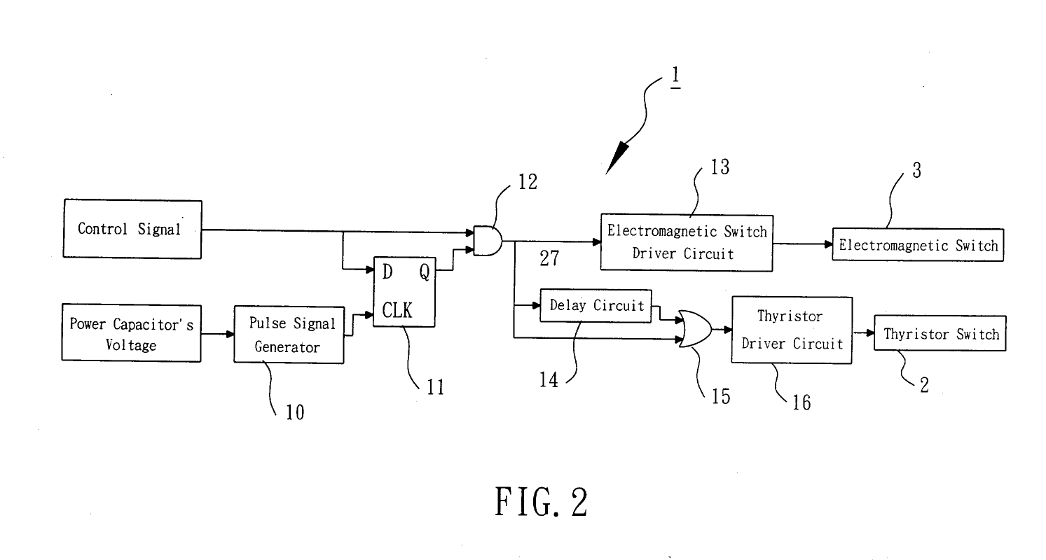

FIG. 2 illustrates a control block diagram of the hybrid switch module for AC power capacitor in accordance with a first embodiment of the present invention. Referring to FIG. 2, the control circuit 1 of the hybrid switch module for AC power capacitor in accordance with the first embodiment includes a pulse signal generator 10, a D type flip-flop 11, an AND gate 12, an electromagnetic switch drive circuit 13, a delay circuit 14, an OR gate 15, and a thyristor drive circuit 16. The control circuit 1 retrieves a voltage across the hybrid switch module and then sends to the pulse signal generator 10 so as to produce a pulse signal while the voltage of hybrid switch module near zero. The pulse signal is operated as a CLK signal of the D type flip-flop 11. The switch control signal is sent to the input D of the D type flip-flop 11. The output of the D type flip-flop 11 and the switch control signal are operated as the input signals of the AND gate 12. Output of the AND gate 12 is fed to the driving circuit 13 of electromagnetic switch, the OR gate and the delay circuit 14. Output of the delay circuit 14 is also as the other input of the OR gate 15, and then the output of OR gate 15 is fed to the driving circuit 16 of thyristor.

During the turn on process, the switch control signal is set as a high level to turn on the AC power capacitor and the input signal D of the D type flip-flop 11 is used to maintain as a high level. The output state of D type flip-flop 11 is not changed at this time, and it will be changed until the voltage across the hybrid switch module is at the zero crossing point. At this time, the pulse signal generator 10 will produce a pulse as CLK signal of the D type flip-flop 11, and then the output of D type flip-flop is changed to high level. In this instant, both input signals of the AND gate 12 are a high level, the output of the AND gate 12 is turned to a high level. Then, the driving circuit 13 of electromagnetic switch and the input of OR gate 15 is turned to a high level. The output of the OR gate 15 and the driving circuit 16 of the thyristor are also turned to a high level. The thyristor switch 2 and the electromagnetic switch 3 will be actuated or triggered in this instant. Because the transition time of the thyristor switch 2 is shorter, the thyristor can be turned on firstly at the instant while the voltage across the hybrid switch module is near zero. On the contrary, the response time of the electromagnetic switch 3 is relatively slow, and it can be turned on after a few milliseconds delay. Due to thyristor switch 2 turns on the AC power capacitor at the time when the voltage across the hybrid switch module is at the zero crossing point, there is no instant voltage change on the AC power capacitor. Hence, the inrush current of AC power capacitor due to turn on can be avoided. Because the thyristor can withstand a short term overcurrent, the thyristor switch 2 is only conducted before the electromagnetic switch 3 is turned on and almost no inrush current, a relatively small power rating of the thyristor and the electromagnetic switch are used in the present invention. Because the impedance of the electromagnetic switch 3 is obviously smaller than that of the thyristor switch 2, and the electromagnetic switch 3 electrically connected to the thyristor switch 2 in parallel, the thyristor switch 2 is disable automatically after the electromagnetic switch 3 is turned on. After the electromagnetic switch 3 is turned on, most of current pass through the electromagnetic switch 3 and thereby minimizes power loss on the thyristor switch 2 to eliminate the requirement of vast dimension of a heatsink and cooling fan so that the efficiency of the hybrid switch module for the AC power capacitor is improved.

The low level of the switch control signal represents to turn off the AC power capacitor. During the turn off process, the output of the AND gate 12 is turned into a low level to turn off the electromagnetic switch 3. Because the turn off time of the electromagnetic switch 3 is relatively longer than that of the thyristor switch 2, the driving signal of thyristor switch 2 should be removed after a delay time to ensure that the electromagnetic switch 3 is turned off before the thyristor switch 2 is turned off. The delay circuit 14 is used to set the delay time. After the delay time, the driving signal of thyristor switch 2 is removed, and then it is turned off automatically when the current passing through is at the zero crossing point. The AC power capacitor and the electromagnetic switch 3 are turned off at zero current, and there is no arcing problem. Hence, the present invention can extend the life of the AC power capacitor and the electromagnetic switch 3.

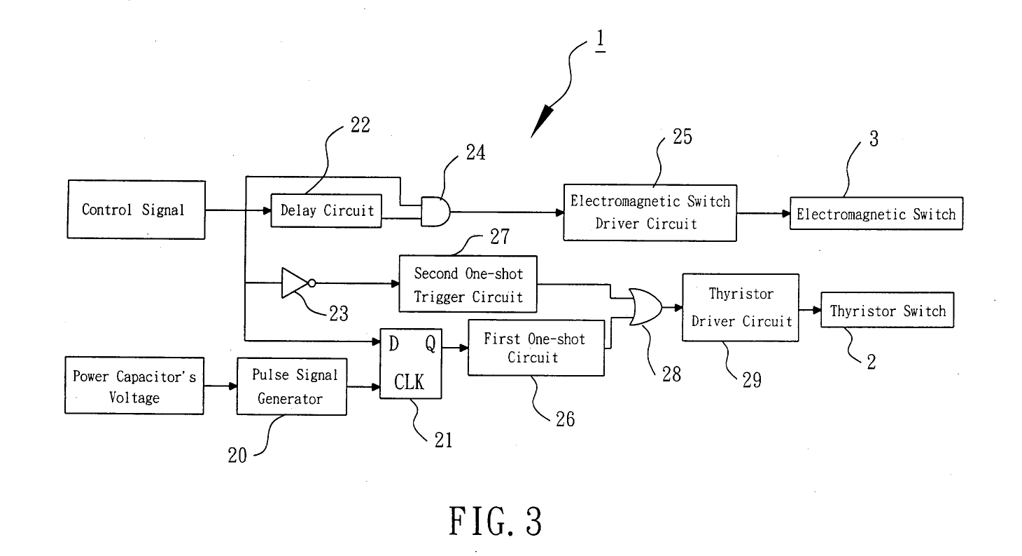

FIG. 3 illustrates a control block diagram of the hybrid switch module for the AC power capacitor in accordance with a second embodiment of the present invention. Referring to FIG. 3, the control circuit 1 of the hybrid switch module for AC power capacitor in accordance with the second embodiment includes a pulse signal generator 20, a D type flip-flop 21, a delay circuit 22, a NOT gate 23, an AND gate 24, an electromagnetic switch drive circuit 25, a first one-shot circuit 26, a second one-shot circuit 27, an OR gate 28, and a thyristor drive circuit 29. The control circuit 1 retrieves a voltage across the hybrid switch module to output to the pulse signal generator 20 so as to produce a pulse signal while the voltage across hybrid switch module near zero. The pulse signal as a CLK signal is fed to the D type flip-flop 21. The switch control signal is operated as the input D of the D type flip-flop 21 and the NOT gate 23. Outputs of the D type flip-flop 21 and the NOT gate 23 are fed to the first one-shot circuit 26 and the second one-shot circuit 27 respectively. Outputs of the first one-shot circuit 26 and the second one-shot circuit 27 are sent to the OR gate 28, and then the output of OR gate 28 is fed to the driving circuit 29 of thyristor. The switch control signal is also fed to the delay circuit 22 and the AND gate 24. Output of the AND gate 24 is sent to the driving circuit 25 of electromagnetic switch.

During the turn on process, the switch control signal is set as a high level to turn on the AC power capacitor and the input signal D of the D type flip-flop 21 is used to maintain as a high level. The output state of D type flip-flop 21 is not changed at this time, and it will be changed until the voltage across the hybrid switch module is at the zero crossing point. The pulse signal generator 20 will produce a pulse as CLK signal of the D type flip-flop 21 when the voltage across the hybrid switch module is at the zero crossing point. In this time, the output of the D type flip-flop 21 will turn into a high level to form a positive edge signal. The positive edge signal is sent to trigger the first one-shot circuit 26 so as to generate a high level signal with a one-shot time interval depending upon parameters of the first one-shot circuit 26. The output of the first one-shot circuit 26 is sent to the OR gate 28, and then output of the OR gate 28 is a high level and it can trigger the driving circuit 29 of thyristor. The output of the driving circuit 29 of thyristor is used to trigger the thyristor switch 2. Because the transition time of the thyristor switch 2 is shorter, the thyristor switch 2 is almost turned on immediately when the driving signal is applied. Due to the voltage across the AC power capacitor at this instant is at the zero crossing point, the problem of the AC power capacitor inrush current at turning on can be avoided. On the contrary, the response time of the electromagnetic switch 3 is relatively slow, and it can be turned on after a few milliseconds delay. Because the impedance of the electromagnetic switch 3 is obviously smaller than that of the thyristor switch 2, and the electromagnetic switch 3 electrically connected to the thyristor switch 2 in parallel, the thyristor switch 2 is disabled automatically after the electromagnetic switch 3 is turned on. Because the thyristor switch 2 will be disabled automatically after the electromagnetic switch 3 being turned on, an one-shot time interval of the first one-shot circuit 26 must be longer than complete turn-on time of the electromagnetic switch 3. After one-shot time, the output of the OR gate 28 is turned to a low level and the driving signal of thyristor switch 2 is removed. It can further save the driving power of thyristor switch 2. It means that the thyristor switch 2 operates only a few cycles. Because the thyristor can withstand a short time overcurrent, the thyristor switch 2 is only conducted before the electromagnetic switch 3 is turned on and almost no inrush current, a relatively small capacity rating of the thyristor switch 2 and the electromagnetic switch 3 are used in the present invention. After the electromagnetic switch 3 is turned on, all of the current passes through the electromagnetic switch 3 and thereby minimizes power loss on thyristor switch 2 to eliminate vast dimension of a heatsink and electric fan so that the efficiency of the hybrid switch module for AC power capacitor is improved.

During the turn off process, since the low level of the switch control signal presents to turn off the AC power capacitor, the input control signal may turn into a negative edge signal of a low level from a high level. The negative edge signal is passed through the NOT gate 23 to turn into a positive edge signal to trigger the second one-shot circuit 27. The second one-shot circuit 27 produces a high level signal with a one-shot time interval depending upon parameters of the second one-shot circuit 27. The output of the second one-shot circuit 27 is sent to the OR gate 28 and the output of the OR gate is sent to the driving circuit 29 of the thyristor for re-triggering the thyristor switch 2. The electromagnetic switch 3 is instantly turned off by the low level of the output of the AND gate 24 due to the low level of the switch control signal. The conduction of the thyristor switch 2 must maintain a few milliseconds depends on the one-shot time of second one-shot circuit 27 to guarantee that the electromagnetic switch 3 is turned off before the thyristor switch 2 is turned off. After the one-shot time of second one-shot circuit 27, the output of the driving circuit 29 of the thyristor returns to low level and the thyristor switch is turned off automatically at the zero crossing point of the capacitor current. Consequently, it can avoid electric arc and high voltage on the electromagnetic switch 3 and the AC power capacitor. Hence, the present invention can extend the life of the AC power capacitor and the electromagnetic switch 3.

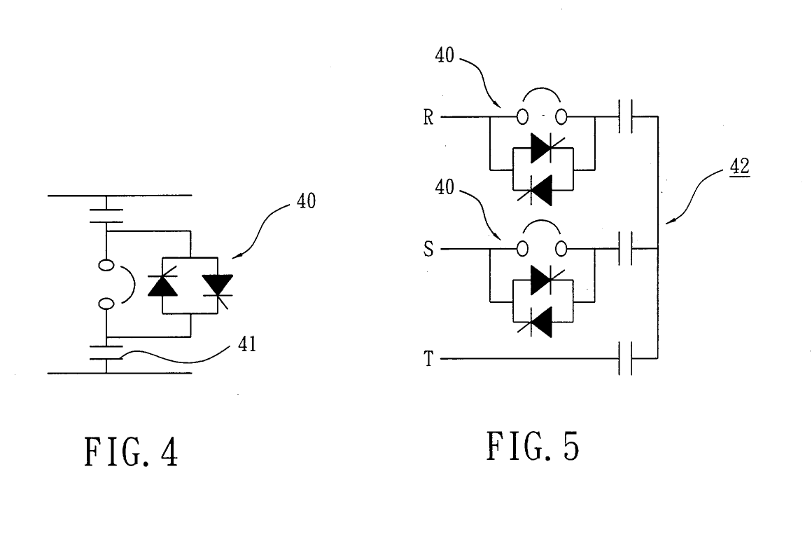

FIG. 4 illustrates a circuitry diagram of the hybrid switch module 40 and an AC power capacitor 41 applying in single-phase power system in accordance with the present invention. Referring to FIG. 4, the hybrid switch module 40 and the AC power capacitor 41 are electrically connected in series.

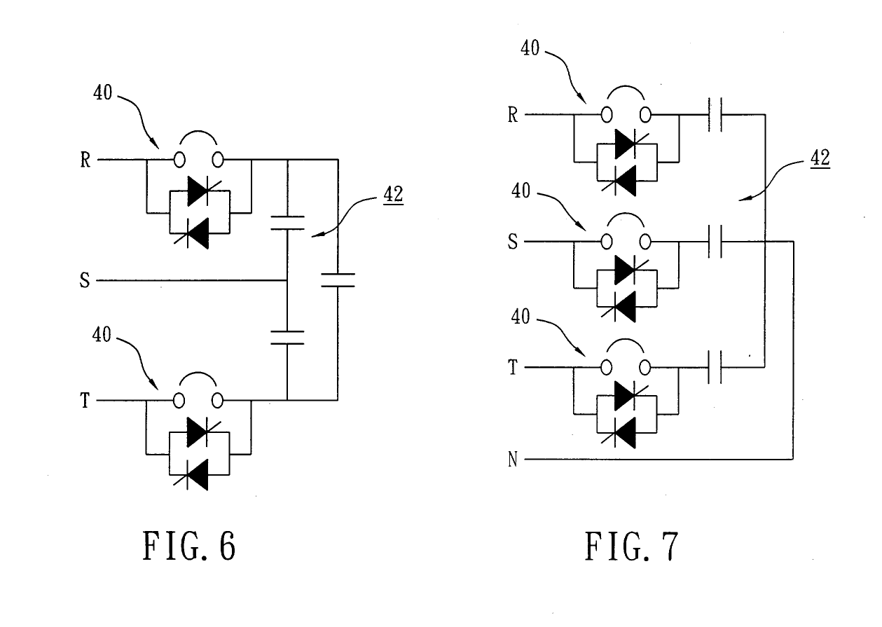

FIGS. 5 and 6 illustrate a circuitry diagram of the hybrid switch module 40 and a Y or delta connection AC power capacitor 42 applying in 3-phase 3-line distribution power system in accordance with the present invention. Referring to FIGS. 5 and 6, two sets of hybrid switch modules 40 are connected to the two phases of the Y or delta connection AC power capacitor 42. Alternatively, three sets of hybrid switch modules 40 are connected to the three phases of the Y or delta connection AC power capacitor 42.

FIG. 7 illustrates a circuitry diagram of the hybrid switch module 40 applying in 3-phase 4-wire distribution power system in accordance with the present invention. Referring to FIG. 7, three sets of hybrid switch modules 40 are connected to the three phases of the AC power capacitor 42.

Although the invention has been described in details with references to its presently preferred embodiment, it will be understood by one of ordinary skill in the art that various modifications can be made without departing from the spirit and the scope of the invention, as set forth in the appended claims.

What is claimed is:

1. A hybrid switch module for an AC power capacitor comprising:
a control circuit received control signals being used to generate a driving signal to turn on the hybrid switch module;
a thyristor switch turned on or off by control signals generated by the control circuit; and
an electromagnetic switch electrically connected to the thyristor switch in parallel and also turned on or off by the control signals generated by the control circuit;
during the turn on process, in order to minimize the inrush current on energized power capacitor, the control signal drives the thyristor switch and the electromagnetic switch while a voltage across the thyristor switch near zero, and then the thyristor switch can turn on immediately while receiving the driving signal due to its rapid switching performance; the electromagnetic switch is turned on after about ten milliseconds or more delay due to its slow switching performance; the thyristor switch is disabled while the on duration of electromagnetic switch automatically;
during the turn off process, a control signal actuates to turn off the electromagnetic switch and the thyristor switch is enabled again simultaneously to avoid electric arc; after the electromagnetic switch is turned off completely, the driving signal of thyristor switch is removed, and thyristor switch turns off while current flowing through is near zero.

2. The hybrid switch module for power capacitor as defined in claim 1, the inrush current of power capacitor in turning on process is suppressed therefore a small capacity of electromagnetic switch can be selected, and no arc in electromagnetic switch during turning off, therefore, both the life of power capacitor and electromagnetic switch can be extended.

3. The hybrid switch module for power capacitor as defined in claim 1, the thyristor switch is not conducted except a turn on/off duration, a conduction time of thyristor is very short, then a significant small capacity of the thyristor can be selected and no heatsink is required, therefore a volume thereof can be reduced.

4. The hybrid switch module for power capacitor as defined in claim 1, wherein the hybrid switch module applying in single-phase distribution power system, and connected to the power capacitor in series.

5. The hybrid switch module for power capacitor as defined in claim 1, wherein two sets of the hybrid switch modules are connected to the two phases of a Y or delta connection power capacitor when the hybrid switch modules applying in 3-phase 3-wire distribution power system.

6. The hybrid switch module for power capacitor as defined in claim 1, wherein three sets of the hybrid switch modules are connected to the three phases of a Y or delta connection power capacitor when the hybrid switch modules applying in 3-phase 3-wire distribution power system.

7. The hybrid switch module for power capacitor as defined in claim 1, wherein three sets of the hybrid switch modules are connected to the three phases of power capacitors when the hybrid switch modules applying in 3-phase 4-wire distribution power system.
